(19) United States
(12) Patent Application Publication
(10) Pub. No.: US 2023/0130768 A1
(43) Pub. Date: Apr. 27, 2023

(54) Floral Gifting Reservation System

(71) Applicant: Eric Bustos, Lighthouse Point, FL (US)

(72) Inventor: Eric Bustos, Lighthouse Point, FL (US)

(21) Appl. No.: 17/507,542

(22) Filed: Oct. 21, 2021

(51) Int. Cl. G06Q 30/06; G06Q 10/02; H04L 12/58

(52) U.S. Cl. CPC G06Q 30/0621; G06Q 10/02; G06Q 30/0637; H04L 51/046

(57) ABSTRACT

A floral gifting reservation system with automated, reoccurring features and is compatible with existing e-commerce platforms is disclosed. The system allows users to input flower delivery reservation dates and events (such as but not limited to birthdays, anniversaries and holidays etc.) along with a party of interest (spouse, parents, family members etc.); and associate floral arrangements for each party using existing e-commerce point of sale platforms (such as shopify etc.). The system then ensures gifts are delivered to the parties on the preset dates automatically. An object of the invention is to ensure loved ones always receive a floral gift on special occasions. Another important object is to redefine the floral model by providing ‘just-in-time’ delivery and eliminating waste in the floral industry.

### CROSS-REFERENCE TO RELATED APPLICATIONS

This application claims the benefit of U.S. Provisional Patent Application No. 63/188,428 filed on May 13, 2021.

### FIELD OF THE INVENTION

The present invention generally relates to reminder software. More specifically, it relates to a program that allows for automatic gifting during preset dates.

### BACKGROUND

The digital era that began in the 1980s was heralded as a way to boost productivity and allow the white collar work force more free time. Then came the digital information revolution and that claimed everyone would stay more connected to one another. Sadly, just the opposite is true—individuals are more encumbered with technology tools and are more distracted leaving most feeling over-worked, lonely and less connected to one another. Many of these conditions cannot be reversed and the information age is here to stay—in order to reverse some of these trends, technology can be leveraged to combat disconnectedness. What is needed is a reminder program that allows busy users to appreciate loved ones through automatic gifting on preset, special occasions.

### SUMMARY OF THE INVENTION

The device herein disclosed and described provides a solution to the shortcomings in the prior art through the disclosure of a system and method for enhanced, automated gifting. For example, an extremely busy person can login to the software and make reservations for family members, friends and coworkers. When each date arrives, the system fulfills the order and flowers are delivered to each person automatically at the right time and place. In other embodiments, the system software may coordinate with other florists to fulfill local orders.

Another object of the invention is to provide a highly detailed intake process. When a user configures a reservation they can select exact dates from an online calendar, set the level of flower gifting reoccurrence, build and populate a custom recipient list, as well as selecting the gift that will be sent.

Another object of the invention is to allow gifts to be purchased and delivered automatically. The software is compatible with existing, online e-commerce platforms. Users configure the program with their payment options and once a preset date arrives, the software instantly communicates the preset order and the gift is processed and delivered to the recipient.

Another object of the invention is to personalize a flower gift. Users can input a message along with a flower gift. For example, a user programs a bouquet of flowers be delivered to a wife during her birthday. To personalize the gift he inputs the message “love always, Tim” into the input dialog box during the reservation phase of the process. In other embodiments, users can also choose from a predefined list of quotes stored in the cloud network database for selection if they are either unsure what to say or they know exactly what they want to say.

Another object of the invention is to allow users to automatically receive transaction notifications. Before a reservation date arrives, the software sends a text message stating that a flower gift is about to be purchased and sent. Once a gift arrives, the user receives a notification that the flower gift has been delivered along with a receipt of purchase.

Another object of the invention is to allow the user to archive and organize all flower gifting activity. The software contains a dashboard that allows users to store and access historical gifts data over time. The dashboard also gives users the ability to add, change, and/or remove any reservations at any time.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the gifting reservation system in use.

FIG. 2 shows a representative view of the method.

FIG. 3 shows a representative view of the process.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

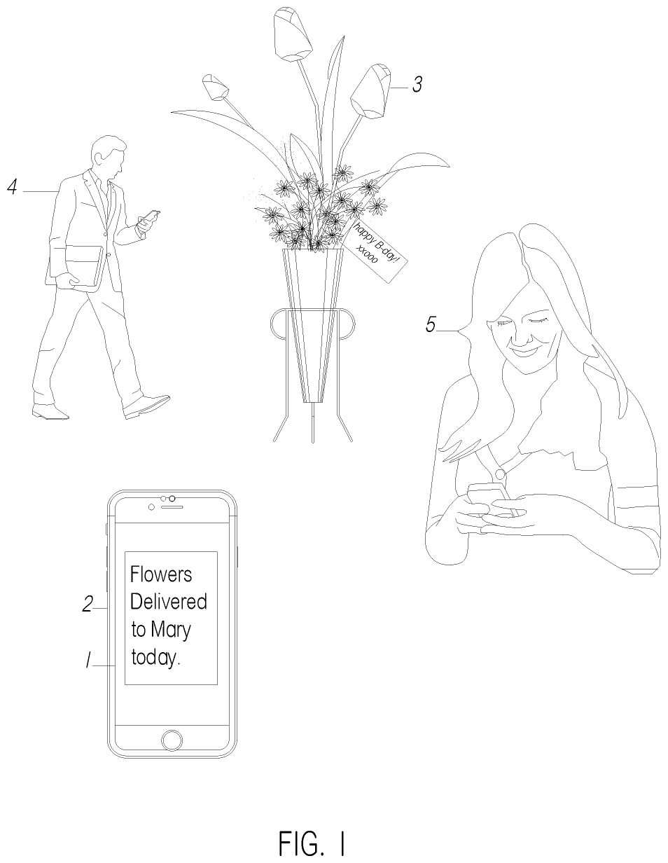

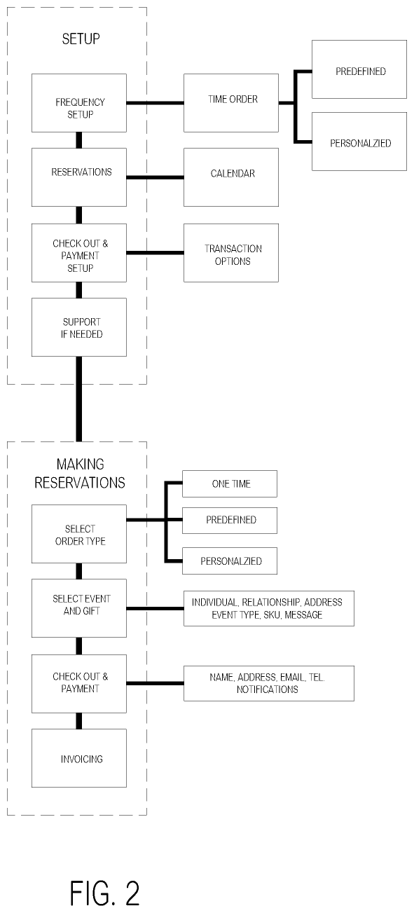

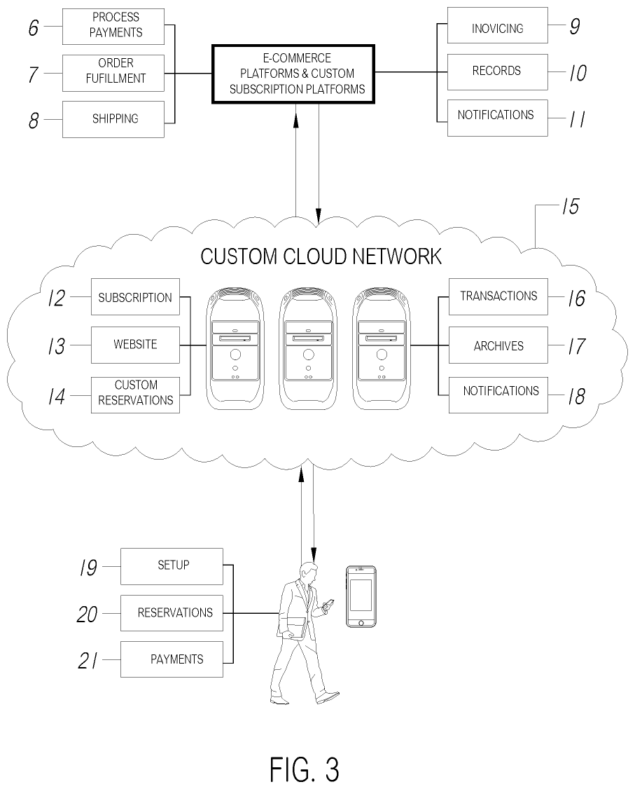

FIG. 1 shows a perspective view of the floral gifting reservation system in use wherein the system automatically placing an order of flowers 3 being ordered and delivered to recipient 5 automatically and user 4 receiving notification via the software's application 1 on a smart phone 2 that the gift has been received. Said mobile device application is comprised of a non-transitory computer readable medium that includes computer-readable instructions. FIG. 2 showing both the setup and making reservation methods. The setup includes but is not limited to: setting the frequency of gifting which includes predefining the order timing (weekly month etc.), and personalizing the order (special events etc.); configuring reservations (using an online calendar); checking out and payment setup (venmo, paypal etc.); setting transaction options (selecting e-commerce platforms); and seeking support if needed (chat, call center etc.). The figure also showing the method a user takes to make a reservation that includes but is not limited to: selecting an order type (one time, predefined, or personalized); selecting the event and gift type; choosing recipient (relationship, address, event, SKU, message etc.); performing purchase and payment to vendor; receiving vendor notification (recipient email, address, email, tel., and notifications); and invoicing (storing transaction records etc.). FIG. 3 showing the gifting reservation system's process wherein the user having operations that include but are not limited to: setting up and configuring the software 19; making reservations 20; and making payments 21. Vendors (such as shopify, zapiet and paywhirl etc.) having operations that include but are not limited to: processing user payments 6; fulfilling gifting orders 7; shipping arrangement for said gifts 8; invoicing user directly 9; purchase history and records 10 and notifications 11 (email, SMS, text etc.).

Both vendors and user being connected by proprietary cloud network 15 having functions and algorithms that include but are not limited to: subscription services 12 (tiers of service and monthly payments for the service if available or desired); website portal 13 (API and backend etc.); reservation algorithms 14 (one time, predefined and personalized schedules); governing financial transactions 16 (gifting selection, payments, receipts etc.); archives 17 (encrypted sales history records accessible to user); and notifications to vendors and users 18 (text, email, SMS etc.).

In view of the disclosure provided herein, a mobile application is created by techniques known to those of skill in the art using hardware, languages, and development environments known to the art. Those of skill in the art will recognize that mobile applications are written in several languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof. The software also compatible with a plurality of operating systems such as, but not limited to: Windows™, Apple™, and Android™, and compatible with a multitude of hardware platforms such as, but not limited to: personal desktops, laptops, tablets, smartphones and the like. Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™ Visual Basic, and VB .NET, or combinations thereof. Compilation is often performed, at least in part, to create an executable program. In some embodiments, a computer program includes one or more executable complied applications. In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof. Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser. Software Modules.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A floral gifting reservation system comprised of the following parts:
a) a software application; and
b) a cloud network.

2. The floral gifting reservation system of claim 1, wherein the software application is comprised of a non-transitory computer-readable medium that includes computer readable instructions.

3. The floral gifting reservation system of claim 1, wherein the cloud network having subscription services with tiers of service and monthly payments.

4. The floral gifting reservation system of claim 1, wherein the cloud network having a website portal with API and backend.

5. The floral gifting reservation system of claim 1, where in the cloud network having reservation algorithms with onetime, predefined and personalized schedules.

6.-17. (canceled)
